(19) United States
(12) Patent Application Publication
(10) Pub. No.: US 2006/0117500 A1
(43) Pub. Date: Jun. 8, 2006

(54) Mixtures of fiber-reactive azo dyes, production thereof and use thereof

(75) Inventors: Stefan Meier, Frankfurt am Main (DE); Uwe Reiher, Hofheim (DE); Werner Russ, Florsheim-Wicker (DE); Christian Schumacher, Kelkheim (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 11/289,187

(22) Filed: Nov. 29, 2005

(30) Foreign Application Priority Data
Dec. 2, 2004 (DE) 10 2004 058 151.7

(51) Int. Cl. C09B 67/00

(52) U.S. Cl. 8/527

(57) ABSTRACT

Mixtures of fiber-reactive azo dyes, production thereof and use thereof Dye mixtures comprising a dye of the hereinbelow indicated and defined general formula (1) 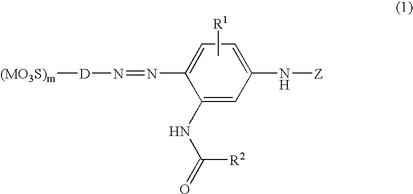
and a dye of the hereinbelow indicated and defined general formula (2) 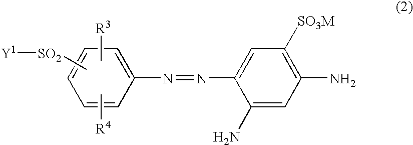 where

M, m, D, Y¹, R¹; R², R³, R⁴ and Z are each as defined in claim 1, their production and their use for dyeing and printing hydroxyl- and/or carboxamido-containing fibers

This invention relates to the technical field of fiber-reactive azo dyes

Numerous fiber-reactive dyes are described in the patent literature as useful for dyeing or printing hydroxyl- and/or carboxamido-containing fibers, such as cellulosic fibers in particular, to produce yellow dyeings. Of these dyes, it is especially those which are known from the documents DE 3102287, U.S. Pat. No. 5,298,607 and from EP 0021105 which are of industrial interest.

However, these conventional yellow-dyeing dyes do not adequately meet the latest requirements with regard to their use in specific dyeing processes, the dyeability of fibers and the fastness properties of dyeings obtainable therewith.

The DE 19851497 document further describes yellow-dyeing fiber-reactive dye mixtures which, however, are in need of improvement in buildup and fixing ability, in water solubility and storage stability and in the fastness properties of the dyes.

The present invention therefore has for its object to provide fiber-reactive dyes whose dyeing behavior, such as their buildup and fixing ability for example, is improved compared with the known dyes and which, moreover, possess better water solubility and storage stability and whose dyeings have improved fastness properties and are efficiently reproducible.

The present invention, then, provides dye mixtures which meet these requirements and which surprisingly possess distinctly superior fastness properties, of which the alkaline wet lightfastness and also the chlorine fastness are to be particularly emphasized.

The invention accordingly provides dye mixtures comprising a dye of the hereinbelow indicated and defined general formula (1) and a dye of the hereinbelow indicated and defined general formula (2) 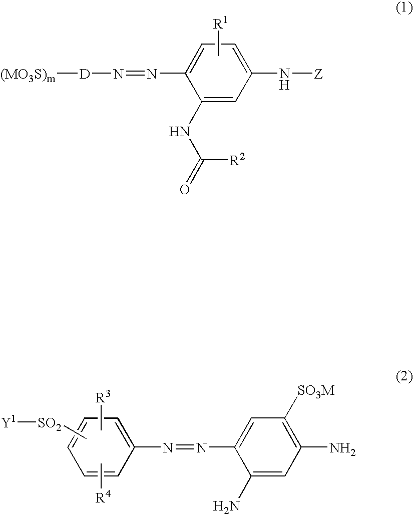
where:
M is hydrogen or an alkali metal, such as sodium, potassium or lithium;
m is 1, 2 or 3, preferably 2 or 3;
D is the radical of benzene or of naphthalene;
Y¹ is vinyl or is ethyl substituted in the β-position by an alkali-eliminable substituent, such as for example by chlorine, sulfato, thiosulfato, phosphato, alkanoyloxy of 2 to 5 carbon atoms, such as acetyloxy, and sulfobenzoyloxy, and is preferably vinyl and sulfatoethyl;
R¹ is hydrogen, alkyl of 1 to 4 carbon atoms, alkoxy of 1 to 4 carbon atoms or sulfo;
R² is amino or unsubstituted alkyl of 1 to 4 carbon atoms or alkyl of 1 to 4 carbon atoms substituted by carboxyl, sulfo or by a group
   —SO₂—Y²
   where Y² has one of the meanings of Y¹,
R³ is hydrogen, chlorine, alkyl of 1 to 4 carbon atoms, such as ethyl and in particular methyl, alkoxy of 1 to 4 carbon atoms, such as ethoxy and in particular methoxy, or sulfo,
R⁴ is hydrogen, alkyl of 1 to 4 carbon atoms or alkoxy of 1 to 4 carbon atoms,
Z is a fiber-reactive radical from the series of the halopyrimidines, of the dichloroquinoxalines or of the halotriazines which optionally bears a radical of the general formula
   —NR⁵—B—SO₂—Y
   where
   R⁵ is hydrogen or C₁-C₄ alkyl,
   B is C₂-C₄-alkylene, or a C₄-C₆ alkylene with or without heteroatom interruption, or phenylene, and
   Y has one of the meanings of Y¹.

The groups “sulfo”, “thiosulfato”, “carboxyl”, “phosphato” and “sulfato” include not only their acid form but also their salt form. Accordingly, sulfo groups are groups conforming to the general formula —SO3M, thiosulfato groups are groups conforming to the general formula —S—SO3M, carboxyl groups are groups conforming to the general formula —COOM, phosphato groups are groups conforming to the general formula —OPO3M2 and sulfato groups are groups conforming to the general formula —OSO3M, in each of which M is as defined above.

M alkali is in particular lithium, sodium and potassium. Preferably, M is hydrogen or sodium.

The molar ratio of dye (1) to dye (2) in the mixtures of the present invention is preferably in the range from 90:10 to 50:50 and more preferably in the range from 80:20 to 60:40

The dyes of the general formula (1) are known for example from the documents DE3102287, U.S. Pat. No. 5,298,607 and EP0021105. Dyes of the general formula (2) are described in the DE1911427 application and can be prepared similarly to the directions given therein.

Preferred dyes of the general formula (2) for the dye mixtures of the present invention are those in which the (MO₃S)ₘ—D— radical is monosulfophenyl, disulfophenyl, disulfonaphth-2-yl and trisulfonapth-2-yl, of these more preferably the radicals 2-sulfophenyl, 2,5-disulfophenyl, 2,4-disulfophenyl, 4,8-disulfonaphth-2-yl, 6,8-disulfonaphth-2-yl and 5,7-disulfonaphth-2-yl, 3,6,8-trisulfonaphth-2-yl and 4,6,8-trisulfonaphth-2-yl.

The dye mixtures of the present invention are preparable in a conventional manner, as by mechanically mixing the individual dyes, whether in the form of their dye powders or granules or their as-synthesized solutions or of aqueous solutions of the individual dyes in general, which may still contain customary auxiliaries.

The dye mixtures according to the invention can be present as a preparation in solid or liquid (dissolved) form. In solid form, they contain, to the extent necessary, the electrolyte salts customary in the case of water-soluble and especially fiber-reactive dyes, such as sodium chloride, potassium chloride and sodium sulfate, and may further contain the auxiliaries customary in commercial dyes, such as buffer substances capable of setting a pH in aqueous solution between 3 and 7, for example sodium acetate, sodium citrate, sodium borate, sodium bicarbonate, sodium dihydrogenphosphate and disodium hydrogenphosphate, also dyeing auxiliaries, dustproofing agents and small amounts of siccatives; when they are present in a liquid, aqueous solution (including a content of thickeners of the type customary in print pastes), they may also contain substances which ensure a long life for these preparations, for example mold preventatives.

In solid form, the dye mixtures according to the invention are generally present as powders or granules which contain electrolyte salt and which will hereinbelow generally be referred to as a preparation with or without one or more of the abovementioned auxiliaries. In the preparations, the dye mixture is present at 20 to 90% by weight, based on the preparation containing it. The buffer substances are generally present in a total amount of up to 5% by weight, based on the preparation.

When the dye mixtures according to the invention are present in an aqueous solution, the total dye content of these aqueous solutions is up to about 50% by weight, for example between 5 and 50% by weight, the electrolyte salt content of these aqueous solutions preferably being below 10% by weight, based on the aqueous solution; the aqueous solutions (liquid preparations) can contain the aforementioned buffer substances in an amount which is generally up to 5% by weight and preferably up to 2% by weight.

The dye mixtures according to the invention have useful application properties. They are used for dyeing or printing hydroxyl- and/or carboxamido-containing materials, for example in the form of sheetlike structures, such as paper and leather or of films, for example composed of polyamide, or in bulk, such as for example polyamide and polyurethane, but especially for dyeing and printing these materials in fiber form. Similarly, the as-synthesized solutions of the dye mixtures according to the invention can be used directly as a liquid preparation for dyeing, if appropriate after addition of a buffer substance and if appropriate after concentration or dilution.

The present invention thus also provides for the use of the dye mixtures according to the invention for dyeing or printing these materials, or rather processes for dyeing or printing these materials in a conventional manner, by using a dye mixture according to the invention or its individual components (dyes) individually together as a colorant. The materials are preferably employed in the form of fiber materials, especially in the form of textile fibers, such as woven fabrics or yarns, as in the form of hanks or wound packages.

Hydroxyl-containing materials are those of natural or synthetic origin, for example cellulose fiber materials or their regenerated products and polyvinyl alcohols.

Cellulose fiber materials are preferably cotton, but also other vegetable fibers, such as linen, hemp, jute and ramie fibers; regenerated cellulose fibers are for example staple viscose and filament viscose and also chemically modified cellulose fibers, such as aminated cellulose fibers or fibers as described for example in WO 96/37641 and WO 96/37642 and also in EP-A-0 538 785 and EP-A-0 692 559.

Carboxamido-containing materials are for example synthetic and natural polyamides and polyurethanes, especially in the form of fibers, for example wool and other animal hairs, silk, leather, nylon-6,6, nylon-6, nylon-11 and nylon-4.

The dye mixtures according to the invention can be applied to and fixed on the substrates mentioned, especially the fiber materials mentioned, by the application techniques known for water-soluble dyes and especially for fiber-reactive dyes. For instance, on cellulose fibers they produce by the exhaust method from a long liquor and also from a short liquor, for example in a liquor to goods ratio of 5:1 to 100:1, preferably 6:1 to 30:1, using various acid-binding agents and optionally neutral salts as far as necessary, such as sodium chloride or sodium sulfate, dyeings having very good color yields. Application is preferably from an aqueous bath at temperatures between 40 and 105° C., optionally at a temperature of up to 130° C. under superatmospheric pressure, but preferably at 30 to 95° C., especially 45 to 65° C., in the presence or absence of customary dyeing auxiliaries. One possible procedure here is to introduce the material into the warm bath and to gradually heat the bath to the desired dyeing temperature and complete the dyeing process at that temperature. The neutral salts which accelerate the exhaustion of the dyes may also if desired only be added to the bath after the actual dyeing temperature has been reached.

Padding processes likewise provide excellent color yields and a very good color buildup on cellulose fibers, the dyes being fixable in a conventional manner by batching at room temperature or elevated temperature, for example at up to 60° C., or in a continuous manner, for example by means of a pad-dry-pad steam process, by steaming or using dry heat.

Similarly, the customary printing processes for cellulose fibers, which can be carried out in one step, for example by printing with a print paste containing sodium bicarbonate or some other acid-binding agent and by subsequent steaming at 100 to 103° C., or in two steps, for example by printing with a neutral or weakly acidic print color and then fixing either by passing the printed material through a hot electrolyte-containing alkaline bath or by overpadding with an alkaline electrolyte-containing padding liquor and subsequent batching or steaming or dry heat treatment of the alkali-overpadded material, produce strong color prints with well-defined contours and a clear white ground. The outcome of the prints is affected little, if at all, by variations in the fixing conditions.

When fixing by means of dry heat in accordance with the customary thermofix processes, hot air at 120 to 200° C. is used. In addition to the customary steam at 101 to 103° C., it is also possible to use superheated steam and high-pressure steam at temperatures of up to 160° C.

The acid-binding agents which effect the fixation of the dyes of the dye mixtures according to the invention on the cellulose fibers are for example water-soluble basic salts of alkali metals and likewise alkaline earth metals of inorganic or organic acids or compounds which liberate alkali in the heat, and also alkali metal silicates. Especially suitable are the alkali metal hydroxides and alkali metal salts of weak to medium inorganic or organic acids, the preferred alkali metal compounds being the sodium and potassium compounds. Such acid-binding agents are for example sodium hydroxide, potassium hydroxide, sodium carbonate, sodium bicarbonate, potassium carbonate, sodium formate, sodium dihydrogenphosphate, disodium hydrogenphosphate, sodium trichloroacetate, trisodium phosphate or waterglass or mixtures thereof, for example mixtures of aqueous sodium hydroxide solution and waterglass.

The dye mixtures according to the invention when applied to the cellulose fiber materials by dyeing or printing are notable for outstanding color strength, at times achievable in the presence of no or very small amounts of alkali or alkaline earth metal compounds. In these special cases, for instance, no electrolyte salt is required for a shallow depth of shade, not more than 5 g/l of electrolyte salt is required for a medium depth of shade and not more than 10 g/l of electrolyte salt is required for deep shades.

According to the invention, a shallow depth of shade refers to the use of 2% by weight of dye based on the substrate to be dyed, a medium depth of shade refers to the use of 2 to 4% by weight of dye based on the substrate to be dyed and a deep shade refers to the use of 4 to 10% by weight of dye based on the substrate to be dyed.

The dyeings and prints obtainable with the dye mixtures according to the invention possess bright shades; more particularly, the dyeings and prints on cellulose fiber materials possess good lightfastness and especially good wetfastnesses, such as fastness to washing, milling, water, seawater, crossdyeing and acidic and alkaline perspiration, also good fastness to pleating, hotpressing and rubbing. Furthermore, the cellulose dyeings obtained following the customary aftertreatment of rinsing to remove unfixed dye portions exhibit excellent wetfastnesses, in particular since unfixed dye portions are easily washed off because of their good solubility in cold water. The dyeings and prints obtainable with the dye mixtures of the present invention are characterized by their very good alkaline wet lightfastness and also the excellent chlorine fastness.

Furthermore, the dye mixtures according to the invention can also be used for the fiber-reactive dyeing of wool. Moreover, wool which has been given a nonfelting or low-felting finish (cf. for example H. Rath, Lehrbuch der Textilchemie, Springer-Verlag, 3rd edition (1972), pages 295-299, especially finished by the Hercosett process (page 298); J. Soc. Dyers and Colourists 1972, 93-99, and 1975, 33-44) can be dyed to very good fastness properties. The process of dyeing on wool is here carried out in a conventional manner from an acidic medium. For instance, acetic acid and/or ammonium sulfate or acetic acid and ammonium acetate or sodium acetate can be added to the dyebath to obtain the desired pH. To obtain a dyeing of acceptable levelness, it is advisable to add a customary leveling agent, for example a leveling agent based on a reaction product of cyanuric chloride with three times the molar amount of an aminobenzenesulfonic acid and/or of an aminonaphthalenesulfonic acid or on the basis of a reaction product of for example stearylamine with ethylene oxide. For instance, the dye mixture according to the invention is preferably subjected to the exhaust process initially from an acidic dyebath having a pH of about 3.5 to 5.5 under pH control and the pH is then, toward the end of the dyeing time, shifted into the neutral and optionally weakly alkaline range up to a pH of 8.5 to bring about, especially for very deep dyeings, the full reactive bond between the dyes of the dye mixtures according to the invention and the fiber. At the same time, the dye portion not reactively bound is removed.

The procedure described herein also applies to the production of dyeings on fiber materials composed of other natural polyamides or of synthetic polyamides and polyurethanes. In general, the material to be dyed is introduced into the bath at a temperature of about 40° C., agitated therein for some time, the dyebath is then adjusted to the desired weakly acidic, preferably weakly acetic acid, pH and the actual dyeing is carried out at a temperature between 60 and 98° C. However, the dyeings can also be carried out at the boil or in sealed dyeing apparatus at temperatures of up to 106° C. Since the water solubility of the dye mixtures according to the invention is very good, they can also be used with advantage in customary continuous dyeing processes. The color strength of the dye mixtures according to the invention is very high.

The abovementioned dye mixtures can also be formulated into printing inks for digital textile printing.

The printing inks of the present invention comprise one of more of the aforementioned reactive dye mixtures, for example in amounts from 0.1% by weight to 50% by weight, preferably in amounts from 1% by weight to 30% by weight and more preferably in amounts from 1% by weight to 15% by weight based on the total weight of the ink. They may also include combinations of the aforementioned reactive dye mixtures with other reactive dyes used in textile printing.

For the inks to be used in the continuous flow process, a conductivity of 0.5 to 25 mS/m can be set by adding an electrolyte.

Useful electrolytes include for example lithium nitrate and potassium nitrate.

The dye inks of the present invention may include organic solvents at a total level of 1-50% and preferably 5-30% by weight.

Suitable organic solvents are for example
alcohols, for example methanol, ethanol, 1-propanol, isopropanol, 1-butanol, tert-butanol, pentyl alcohol, polyhydric alcohols for example: 1,2-ethanediol, 1,2,3-propanetriol, butanediol, 1,3-butanediol, 1,4-butanediol, 1,2-propanediol, 2,3-propanediol, pentanediol, 1,4-pentanediol, 1,5-pentanediol, hexanediol, D,L-1,2-hexanediol, 1,6-hexanediol, 1,2,6-hexanetriol, 1,2-octanediol, 2-(2-methoxyethoxy)ethanol, 2-(2-ethoxyethoxy)ethanol, 2-(2-butoxyethoxy)ethanol, 2-(2-propoxyethoxy)ethanol,
polyalkylene glycols, for example: polyethylene glycol, polypropylene glycol,
alkylene glycols having 2 to 8 alkylene groups, for example: monoethylene glycol, diethylene glycol, triethylene glycol, tetraethylene glycol, thioglycol, thiodiglycol, butyltriglycol, hexylene glycol, propylene glycol, dipropylene glycol, tripropylene glycol,
low alkyl ethers of polyhydric alcohols, for example: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol monohexyl ether, triethylene glycol monomethyl ether, triethylene glycol monobutyl ether, tripropylene glycol monomethyl ether, tetraethylene glycol monomethyl ether, tetraethylene glycol monobutyl ether, tetraethylene glycol dimethyl ether, propylene glycol monomethyl ether, propylene glycol monoethyl ether, propylene glycol monobutyl ether, tripropylene glycol isopropyl ether, dimethoxypropane, dioxane, ethylpentyl ether,
polyalkylene glycol ethers, such as for example: polyethylene glycol monomethyl ether, polypropylene glycol glycerol ether, polyethylene glycol tridecyl ether, polyethylene glycol nonylphenyl ether,
amines, such as, for example: methylamine, ethylamine, triethylamine, diethylamine, dimethylamine, trimethylamine, dibutylamine, diethanolamine, triethanolamine, N-acetylethanolamine, N-formylethanolamine, ethylenediamine,
urea derivatives, such as for example: urea, thiourea, N-methylurea, N,N′-epsilon dimethylurea, ethyleneurea, 1,1,3,3-tetramethylurea,
amides, such as for example: dimethylformamide, dimethylacetamide, acetamide, ketones or keto alcohols, such as for example: acetone, diacetone alcohol, cyclic ethers, such as for example; tetrahydrofuran, trimethylolethane, trimethylolpropane, 2-butoxyethanol, benzyl alcohol, 2-butoxyethanol, gamma butyrolactone, epsilon-caprolactam, pyridine, piperidine,
further sulfolane, dimethylsulfolane, methylsulfolane, 2,4-dimethylsulfolane, dimethyl sulfone, butadiene sulfone, dimethyl sulfoxide, dibutyl sulfoxide, N-cyclohexylpyrrolidone, N-methyl-2-pyrrolidone, N-ethylpyrrolidone, 2-pyrrolidone, 1-(2-hydroxyethyl)-2-pyrrolidone, 1-(3-hydroxypropyl)-2-pyrrolidone, 1,3-dimethyl-2-imidazolidinone, 1,3-dimethyl-2-imidazolinone, 1,3-bismethoxymethylimidazolidine, butyrolactone, trimethylpropane, 1,2-dimethoxypropane, ethyl acetate, ethylenediaminetetraacetate.
The printing inks of the invention may further include customary additives, for example viscosity moderators to set viscosities in the range from 1.5 to 40.0 mPas in a temperature range from 20 to 50° C. Preferred inks have a viscosity of 1.5 to 20 mPas and particularly preferred inks have a viscosity of 1.5 to 15 mPas.

Useful viscosity moderators include rheological additives, for example: polyvinylcaprolactam, polyvinylpyrrolidone and their copolymers polyetherpolyol, associative thickeners, polyurea, polyurethane, sodium alginates, modified galactomannans, polyetherurea, polyurethane, nonionic cellulose ethers.

As further additives the inks of the invention may include surface-active substances to set surface tensions of 20 to 65 mN/m, which are adapted if necessary as a function of the process used (thermal or piezo technology).

Useful surface-active substances include for example: all surfactants, preferably nonionic surfactants, butyldiglycol, 1,2-hexanediol.

The inks may further include customary additives, for example substances to inhibit fungal and bacterial growth in amounts from 0.01 to 1% by weight based on the total weight of the ink.

The inks may be prepared in a conventional manner by mixing the components in water.

The dye inks of the invention are useful in inkjet printing processes for printing a wide variety of pretreated materials, such as silk, leather, wool, polyamide fibers and polyurethanes, and especially cellulosic fiber materials of any kind. Such fiber materials are for example the natural cellulose fibers, such as cotton, linen and hemp, and also pulp and regenerated cellulose. The printing inks of the invention are also useful for printing pretreated hydroxyl- or amino-containing fibers present in blend fabrics, for example blends of cotton, silk, wool with polyester fibers or polyamide fibers.

In contrast to conventional textile printing, where the printing ink already contains all the fixing chemicals and thickeners for a reactive dye, in inkjet printing the auxiliaries have to be applied to the textile substrate in a separate pretreatment step.

The pretreatment of the textile substrate, for example cellulose and regenerated cellulose fibers and also silk and wool, is effected with an aqueous alkaline liquor prior to printing. To fix reactive dyes there is a need for alkali, for example sodium carbonate, sodium bicarbonate, sodium acetate, trisodium phosphate, sodium silicate, sodium hydroxide, alkali donors such as, for example, sodium chloroacetate, sodium formate, hydrotropic substances such as, for example, urea, reduction inhibitors, for example sodium nitrobenzenesulfonates, and also thickeners to prevent flowing of the motives when the printing ink is applied, for example sodium alginates, modified polyacrylates or highly etherified galactomannans.

These pretreatment reagents are uniformly applied to the textile substrate in a defined amount using suitable applicators, for example using a 2- or 3-roll pad, contactless spraying technologies, by means of foam application or using appropriately adapted inkjet technologies, and subsequently dried.

After printing, the textile fiber material is dried at 120 to 150° C. and subsequently fixed.

The fixing of the inkjet prints prepared with reactive dyes may be effected at room temperature or with saturated steam, with superheated steam, with hot air, with microwaves, with infrared radiation, with laser or electron beams or with other suitable energy transfer techniques.

A distinction is made between one- and two-phase fixing processes:

In one-phase fixing, the necessary fixing chemicals are already on the textile substrate.

In two-phase fixing, this pretreatment is unnecessary. Fixing only requires alkali, which, following inkjet printing, is applied prior to the fixing process, without intermediate drying. There is no need for further additives such as urea or thickener. Fixing is followed by the print aftertreatment, which is the prerequisite for good fastnesses, high brilliance and an impeccable white ground.

The prints produced with the dye inks of the present invention, in particular on cellulosic fiber materials, possess high color strength and a high fiber-dye bond stability not only in the acidic but also in the alkaline region, also good lightfastness and very good wet fastness properties such as fastness to washing, water, seawater, crossdyeing and perspiration, and also good fastness to pleating, hotpressing and rubbing.

The examples hereinbelow serve to illustrate the invention. Parts and percentages are by weight, unless otherwise stated. Parts by weight relate to parts by volume as the kilogram relative to the liter. The compounds described in the examples in terms of a formula are indicated in the form of the sodium salts, since they are generally prepared and isolated in the form of their salts, preferably sodium or potassium salts, and used for dyeing in the form of their salts. The starting compounds described in the examples hereinbelow, especially the table examples, can be used in the synthesis in the form of the free acid or likewise in the form of their salts, preferably alkali metal salts, such as sodium or potassium salts.

### EXAMPLE 1

1000 parts of an aqueous solution comprising 130 parts of the hereinbelow indicated dye of the formula (A-1), such as an as-synthesized solution of this dye, and 1000 parts of an aqueous solution comprising 70 parts of the hereinbelow indicated dye of the formula (B-1), such as an as-synthesized solution of this dye (where M is as defined above, preferably sodium) are mixed with each other.

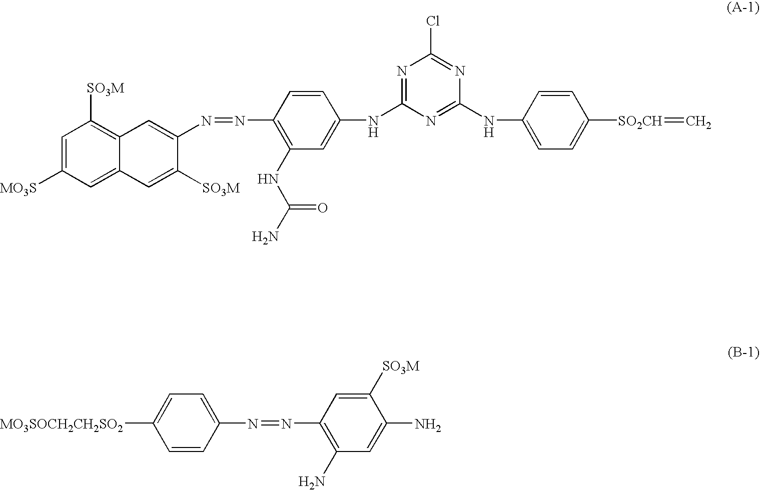

The present invention's dye mixture in a molar mixing ratio of 60:40 for dye (A-1) to dye (B-1) is isolated from the combined solution in a conventional manner, for example by spray-drying the dye solution. The resulting dye mixture according to the present invention, which comprises electrolyte salts from the synthesis, such as sodium chloride and sodium sulfate, demonstrates very good dyeing properties and provides, for example on cellulosic fibrous materials, such as cotton, or regenerated cellulose fibers, in an exhaust dyeing process customary for fiber-reactive dyes, strong and level yellow dyeings possessing good fastness to chlorine.

### EXAMPLE 2

1000 parts of an aqueous as-synthesized solution comprising 150 parts of the dye of the formula (A-2) 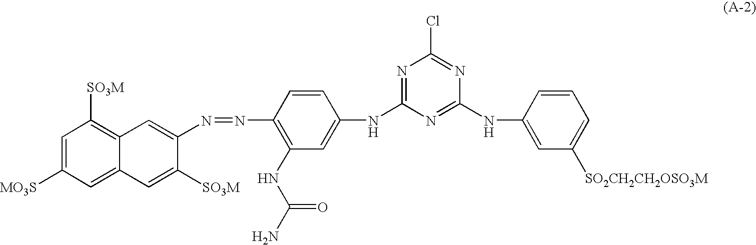
are mixed with 500 parts of an aqueous as-synthesized solution comprising 31.4 parts of the dye of the formula (B-1) (where M is as defined above, preferably sodium) and the dye mixture of the present invention is isolated in a conventional manner, for example by spray-drying the dye solution. The resulting dye mixture according to the present invention, which comprises electrolyte salts from the synthesis, such as sodium chloride and sodium sulfate, and is in a molar mixing ratio of 70:30 for dye (A-2) to dye (B-1), demonstrates very good dyeing properties and provides, for example on cellulosic fibrous materials, such as cotton, or regenerated cellulose fibers, in a cold pad-batch process customary for fiber-reactive dyes, strong and level yellow dyeings possessing good fastness to chlorine.

### EXAMPLE 3

800 parts of an aqueous solution comprising 147 parts of the hereinbelow indicated dye of the formula (A-3) 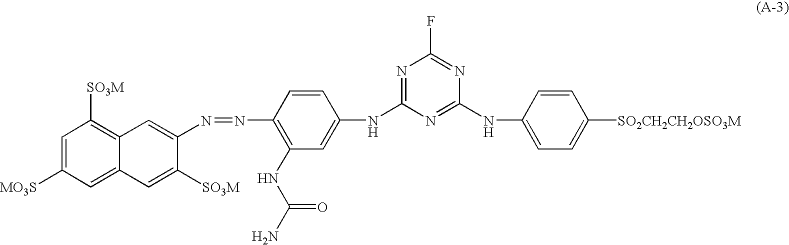
and 400 parts of an aqueous solution comprising 18.3 parts of the dye of the formula (B-1) are mixed with each other.

The present invention's dye mixture in a molar mixing ratio of 80:20 for dye (A-3) to dye (B-1) is isolated from the combined solution in a conventional manner, for example by spray-drying the dye solution. The resulting dye mixture according to the present invention, which comprises electrolyte salts from the synthesis, such as sodium chloride and sodium sulfate, demonstrates very good dyeing properties and provides, for example on cellulosic fibrous materials, such as cotton, or regenerated cellulose fibers, in an exhaust dyeing process customary for fiber-reactive dyes, strong and level yellow dyeings possessing good fastness to chlorine.

### EXAMPLES 4 to 26

The table examples hereinbelow describe further dye mixtures according to the present invention which comprise dyes whose formulas (where M is as defined above) are indicated at the conclusion of the table. The mixtures have very good application properties and provide on the materials mentioned in the description part, as on cellulosic fiber materials in particular, by the application methods customary in the dyeing and printing arts, preferably by the application and fixing methods customary in the art for fiber-reactive dyes, strong yellow dyeings and prints having good fastness properties and a good color buildup.

TABLE

| | | | Molar mixing ratio |
|---|---|---|---|
| Example | Dye (1) | Dye (2) | of (1):(2) |
| 4 | formula (A-1) | formula (B-2) | 60:40 |
| 5 | formula (A-1) | formula (B-3) | 65:35 |
| 6 | formula (A-1) | formula (B-4) | 80:20 |
| 7 | formula (A-1) | formula (B-7) | 80:20 |
| 8 | formula (A-2) | formula (B-2) | 75:25 |
| 9 | formula (A-2) | formula (B-3) | 70:30 |
| 10 | formula (A-2) | formula (B-7) | 70:30 |
| 11 | formula (A-3) | formula (B-2) | 75:25 |
| 12 | formula (A-3) | formula (B-7) | 65:25 |
| 13 | formula (A-4) | formula (B-1) | 65:35 |
| 14 | formula (A-4) | formula (B-2) | 65:35 |
| 15 | formula (A-4) | formula (B-5) | 70:30 |
| 16 | formula (A-4) | formula (B-6) | 65:35 |
| 17 | formula (A-5) | formula (B-1) | 80:20 |
| 18 | formula (A-5) | formula (B-2) | 80:20 |
| 19 | formula (A-5) | formula (B-5) | 75:25 |
| 20 | formula (A-5) | formula (B-6) | 70:30 |
| 21 | formula (A-5) | formula (B-7) | 60:40 |
| 22 | formula (A-6) | formula (B-1) | 65:35 |
| 23 | formula (A-6) | formula (B-2) | 60:40 |
| 24 | formula (A-6) | formula (B-4) | 60:40 |
| 25 | formula (A-6) | formula (B-5) | 80:20 |
| 26 | formula (A-7) | formula (B-1) | 75:25 |
| 27 | formula (A-7) | formula (B-2) | 75:25 |
| 28 | formula (A-7) | formula (B-4) | 75:25 |
| 29 | formula (A-7) | formula (B-7) | 70:30 |
| 30 | formula (A-8) | formula (B-1) | 70:30 |
| 31 | formula (A-8) | formula (B-2) | 70:30 |
| 32 | formula (A-8) | formula (B-4) | 70:30 |
| 33 | formula (A-8) | formula (B-6) | 70:30 |
| 34 | formula (A-9) | formula (B-1) | 80:20 |
| 35 | formula (A-9) | formula (B-2) | 80:20 |
| 36 | formula (A-10) | formula (B-1) | 80:20 |
| 37 | formula (A-10) | formula (B-2) | 75:25 |
| 38 | formula (A-10) | formula (B-7) | 75:25 |

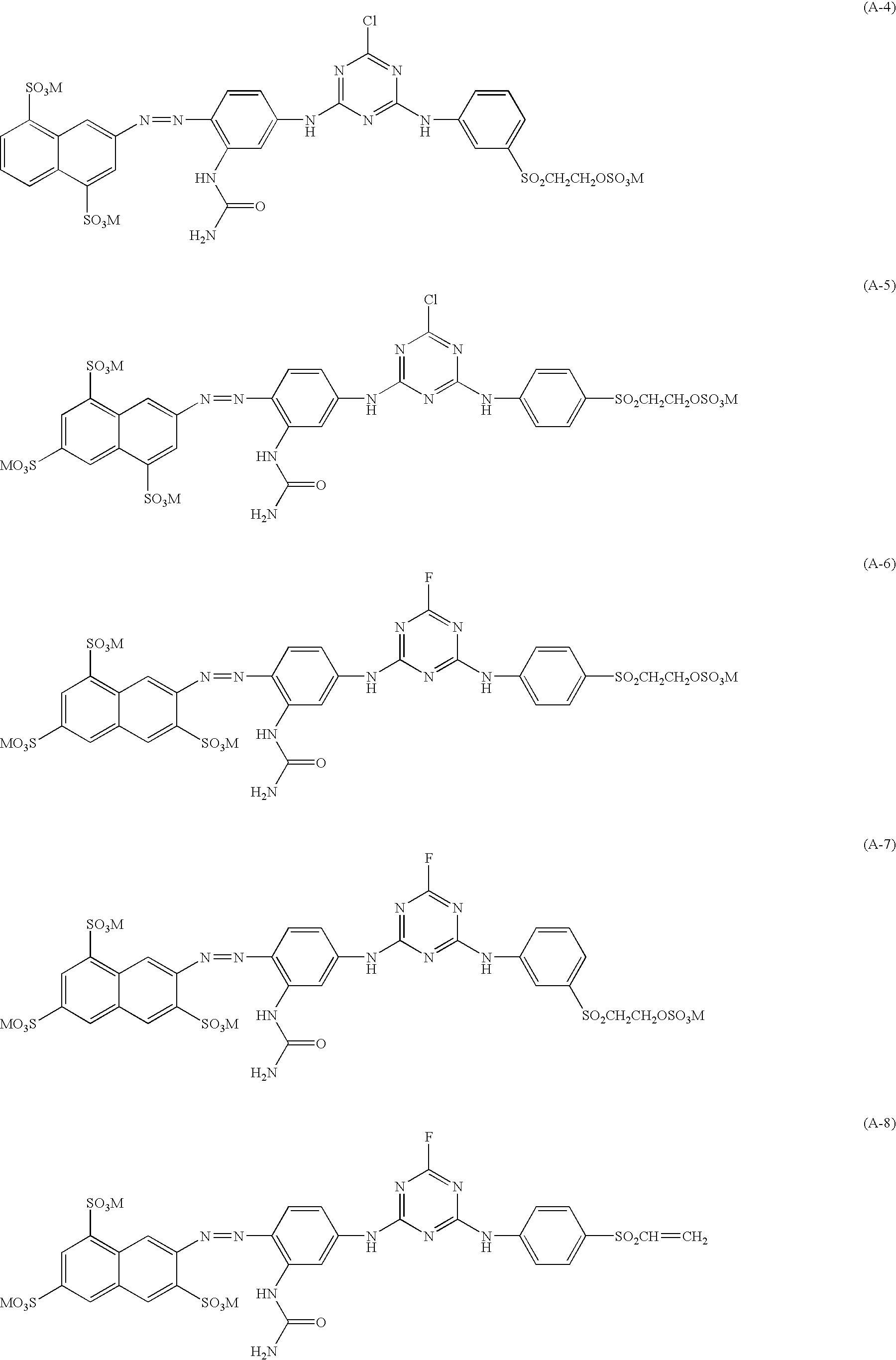

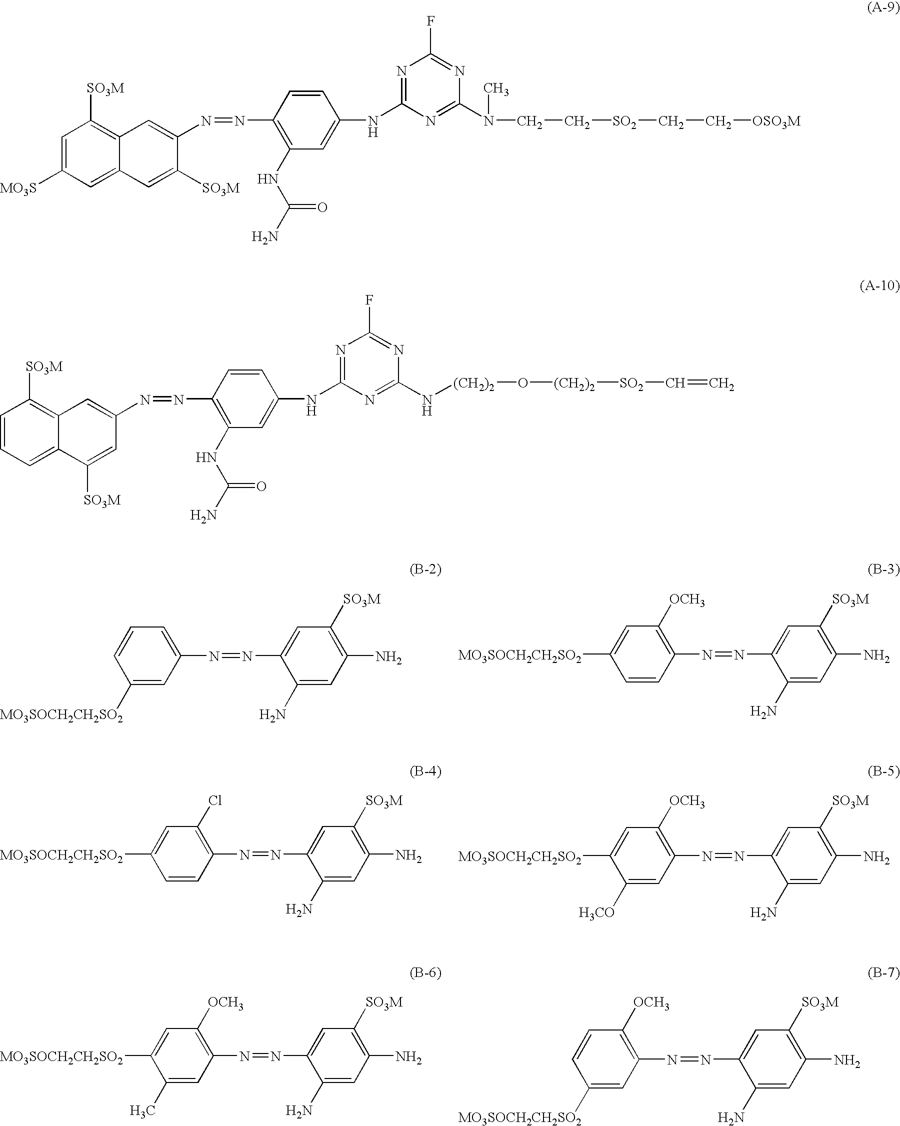

1. Dye mixtures comprising a dye of the hereinbelow indicated and defined general formula (1) 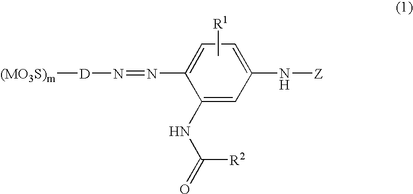
and a dye of the hereinbelow indicated and defined general formula (2) 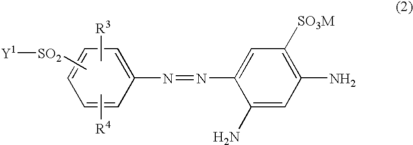
where:
M is hydrogen or an alkali metal;
m is 1, 2or 3,
D is the radical of benzene or of naphthalene;
Y¹ is vinyl or is ethyl substituted in the β-position by an alkali-eliminable substituent;
R¹ is hydrogen, alkyl of 1 to 4 carbon atoms, alkoxy of 1 to 4 carbon atoms or sulfo;
R² is amino or unsubstituted alkyl of 1 to 4 carbon atoms or alkyl of 1 to 4 carbon atoms substituted by carboxyl, sulfo or by a group
—SO₂—Y²
where Y² has one of the meanings of Y¹,
R³ is hydrogen, chlorine, alkyl of 1 to 4 carbon atoms, alkoxy of 1 to 4 carbon atoms or sulfo,
R⁴ is hydrogen, alkyl of 1 to 4 carbon atoms or alkoxy of 1 to 4 carbon atoms,
Z is a fiber-reactive radical from the series of the halopyrimidines, of the dichloroquinoxalines or of the halotriazines which optionally bears a radical of the general formula
—NR⁵—B—SO₂—Y
where
R⁵ is hydrogen or C₁-C₄ alkyl,
B is C₂-C₄-alkylene, or a C₄-C₆ alkylene with or without heteroatom interruption, or phenylene, and
Y has one of the meanings of Y¹.

2. The dye mixtures according to claim 1 which comprise a dye of the hereinbelow indicated and defined general formula (1) and a dye of the hereinbelow indicated and defined general formula (2) 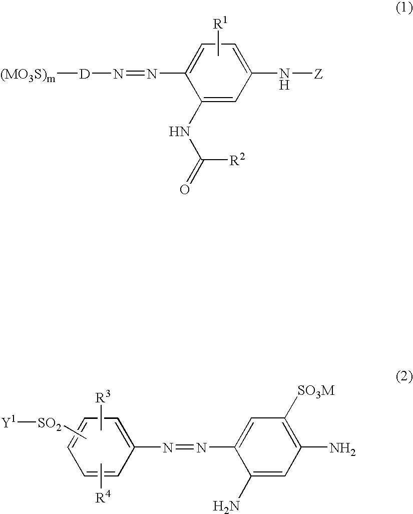
M is hydrogen or sodium, potassium or lithium;
D is the radical of benzene or of naphthalene;
m is 2or 3;
Y1 is vinyl or is ethyl substituted in the β-position by chlorine, sulfato, thiosulfato, phosphato, or acetyloxy, and sulfobenzoyloxy,
R1 is hydrogen, alkyl of 1 to 4 carbon atoms, alkoxy of 1 to 4 carbon atoms or sulfo;
R2 is amino or alkyl of 1 to 4 carbon atoms or alkyl of 1 to 4 carbon atoms substituted by carboxyl, sulfo or by a group
—SO₂—Y²
where Y² has one of the meanings of Y¹,
R³ is hydrogen, methyl, methoxy, ethoxy, chlorine or sulfo,
R⁴ is hydrogen, alkyl of 1 to 4 carbon atoms or alkoxy of 1 to 4 carbon atoms,
Z is a fiber-reactive radical from the series of the halopyrimidines, of the dichloroquinoxalines or of the halotriazines which optionally bears a radical of the general formula
—NR⁵—B—SO₂—Y
where
R⁵ is hydrogen or C₁-C₄ alkyl,
B is C₂-C₄-alkylene, or a C₄-C₆ alkylene with or without heteroatom interruption, or phenylene, and
Y has one of the meanings of Y¹.

3. The dye mixture according to claim 1, wherein
R² is methyl or amino
R³ is hydrogen, methyl, methoxy or chlorine
R⁴ is hydrogen and
Y¹ is vinyl or β-sulfatoethyl.

4. The dye mixture according to claim 1, wherein R¹ is para to the —NH—CO—R² group.

5. The dye mixture according to claim 1, wherein said dye (1) and said dye (2) are present in a molar mixing ratio in the range from 80:20 to 60:40.

6. (canceled)

7. A process for dyeing hydroxyl- and/or carboxamido-containing material, which comprises applying the dye mixture as claimed in claim 1 to the material and fixing on the material by means of heat or with the aid of an alkaline agent or by means of both heat and with the aid of an alkaline agent.

8. Aqueous printing inks for textile printing by the ink jet process, comprising one or more dye mixtures of claim 1 in amounts from 0.01% by weight to 40% by weight based on the total weight of the inks.

9. Aqueous printing inks for textile printing by the ink jet process according to claim 8, further comprising from 1% to 40% of organic solvents based on the total weight of the ink.

10. Aqueous printing inks for textile printing by the ink jet process according to claim 9, comprising from 10% to 30% of organic solvents based on the total weight of the ink.

11. A process for printing textile fibrous materials by the ink jet process, which comprises utilizing one of the inks as claimed in claim 8.

12. Native or regenerated cellulosic fibers, leather, wool, silk, polyamide fibers or polyurethane fibers digitally printed with the inks as claimed in claim 8.

13. The process as claimed in claim 7, wherein the material is a fiber material.
